(19) United States
(12) Patent Application Publication
(10) Pub. No.: US 2026/0000989 A1
(43) Pub. Date: Jan. 1, 2026

(54) PROGRAM, METHOD, AND SYSTEM

(71) Applicant: CYGAMES, INC., Tokyo (JP)

(72) Inventors: Naoyuki Miyashita, Tokyo (JP); Yuichiro Sato, Tokyo (JP); Sadoine Christophe, Tokyo (JP); Kazutaka Oyama, Tokyo (JP); Yingnan Liu, Tokyo (JP); Daiki Watanabe, Tokyo (JP); Yoshinori Iizuka, Tokyo (JP); Junya Kumada, Tokyo (JP); Nobuhiro Koso, Tokyo (JP); Yuki Okabe, Tokyo (JP)

(73) Assignee: CYGAMES, INC., Tokyo (JP)

(21) Appl. No.: 19/317,988

(22) Filed: Sep. 3, 2025

Related U.S. Application Data
(63) Continuation of application No. PCT/JP2024/007841, filed on Mar. 1, 2024.

(30) Foreign Application Priority Data
Mar. 3, 2023 (JP) 2023-032701

(51) Int. Cl. A63F 13/58

(52) U.S. Cl. CPC A63F 13/58

(57) ABSTRACT

According to an example of the present disclosure, a program causes a computer to execute: providing a user with a battle game using a deck including a predetermined number of pieces of game content selected from among a plurality of pieces of game content each of which is assigned a group identifier, the plurality of pieces of game content being capable of being classified into a plurality of groups based on the group identifier; determining at least one group identifier as a reference group identifier, and generating an effect in accordance with the reference group identifier when the battle game is provided.

### TECHNICAL FIELD

The present disclosure relates to a program, a method, and a system.

### BACKGROUND ART

In the related art, a technology of providing a user with a battle game using a deck including a predetermined number of pieces of game content selected from among a plurality of pieces of game content (for example, digital cards) each of which is associated with an attribute is known.

### CITATION LIST

### Patent Literature

Patent Document 1: JP 6804675 B

### SUMMARY OF INVENTION

### Technical Problem

In such a battle game as described above, pieces of game content that can be included in the deck may be periodically added. In such a case, in general, a new piece of game content is often set to have stronger abilities than old pieces of game content. Thus, in the battle game in the related art, it may be difficult to establish a battle between a deck including new pieces of game content and a deck including old pieces of game content without losing its appeal, and in this regard, there is room for further enhancing the appeal of the battle game.

Accordingly, in order to solve one of the problems, an object of the present disclosure is to provide a program, a method, and a system capable of further enhancing the appeal of a battle game.

### Solution to Problem

According to an example of the present disclosure, a program causes a computer to execute: providing a user with a battle game using a deck including a predetermined number of pieces of game content selected from among a plurality of pieces of game content each of which is assigned a group identifier, the plurality of pieces of game content being capable of being classified into a plurality of groups based on the group identifier; determining at least one group identifier as a reference group identifier; and generating an effect in accordance with the reference group identifier when the battle game is provided.

Further, according to another example of the present disclosure, a method is executed by a computer for providing a user with a battle game using a deck including a predetermined number of pieces of game content selected from among a plurality of pieces of game content each of which is assigned a group identifier, the plurality of pieces of game content being capable of being classified into a plurality of groups based on the group identifiers, the method including: determining at least one group identifier as a reference group identifier; and generating an effect in accordance with the reference group identifier when the battle game is provided.

Further, according to still another example of the present disclosure, a system provides a user with a battle game using a deck including a predetermined number of pieces of game content selected from among a plurality of pieces of game content each of which is assigned a group identifier, the plurality of pieces of game content being capable of being classified into a plurality of groups based on the group identifier, the system including: determining at least one group identifier as a reference group identifier; and generating an effect in accordance with the reference group identifier when the battle game is provided.

### BRIEF DESCRIPTION OF DRAWINGS

FIG. 1 is an exemplary and schematic diagram illustrating a configuration of a system according to an embodiment.

FIG. 2 is an exemplary and schematic block diagram illustrating a functional configuration of a terminal apparatus according to the embodiment.

FIG. 3 is an exemplary and schematic sequence diagram illustrating a procedure of processing that is executed by the terminal apparatus and a server apparatus according to the embodiment.

FIG. 4 is an exemplary and schematic diagram illustrating an example of a format selection screen according to the embodiment.

FIG. 5 is an exemplary and schematic diagram illustrating an example of a group selection screen according to the embodiment.

FIG. 6 is an exemplary and schematic diagram illustrating an example of a special ability icon according to the embodiment.

FIG. 7 is an exemplary and schematic diagram illustrating an example of a deck building screen according to the embodiment.

FIG. 8 is an exemplary and schematic diagram illustrating an example of a battle start screen according to the embodiment.

FIG. 9 is an exemplary and schematic diagram illustrating an example of a battle screen according to the embodiment.

FIG. 10 is an exemplary and schematic diagram illustrating an example of a battle screen according to the embodiment different from the battle screen in FIG. 9.

FIG. 11 is an exemplary and schematic diagram illustrating an example of a pause screen according to the embodiment.

FIG. 12 is an exemplary and schematic block diagram illustrating an example of a hardware configuration of an information processing apparatus including the terminal apparatus and the server apparatus according to the embodiment.

### DESCRIPTION OF EMBODIMENTS

### Embodiments

Hereinafter, embodiments of a program, a method, and a system according to the present disclosure will be described with reference to the drawings. The configurations of the embodiments, which will be described below, and functions and effects provided by the configurations are merely examples and are not limited to the following description.

In addition, although ordinal numbers such as “first” and “second” are used as necessary in the following description, these ordinal numbers are used for convenience of identification and do not indicate specific priorities.

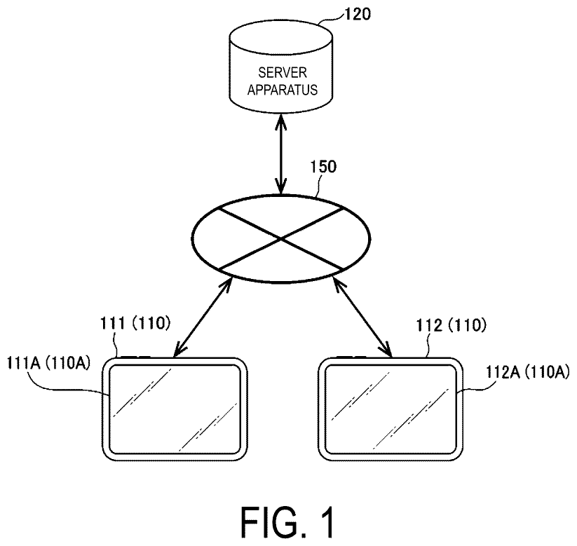

FIG. 1 is an exemplary and schematic diagram illustrating a configuration of a system according to an embodiment.

As illustrated in FIG. 1, the system according to the embodiment includes a plurality of terminal apparatuses 110 each of which includes a display 110A including a touch panel and a server apparatus 120. The terminal apparatus 110 and the server apparatus 120 are communicably connected to each other via a network 150 such as the Internet.

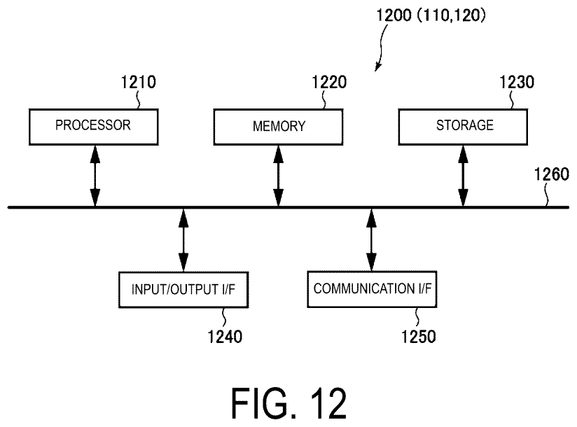

Note that the configuration illustrated in FIG. 1 is merely an example and does not limit the technical idea of the present disclosure. For example, FIG. 1 illustrates terminal apparatuses 111 and 112 configured as tablet computers respectively including displays 111A and 112A as examples of the terminal apparatus 110 including the display 110A. However, the number of terminal apparatuses 110 may be three or more, and the terminal apparatus 110 may be configured as an electronic device other than the tablet computer as long as the terminal apparatus has a configuration equivalent to that of a general computer (a specific example will be described later with reference to FIG. 12).

With the configuration described above, in the embodiment, a battle game is provided between users of the terminal apparatuses 110 via the network 150. For example, in the embodiment, the battle game is a battle game using a deck including a predetermined number of cards selected from, for example, digital cards (hereinafter, simply referred to as cards) as a plurality of pieces of game content each of which is associated with an attribute (hereinafter, referred to as a class).

For example, in the embodiment, the user of each terminal apparatus 110 owns cards provided by the administrator of the battle game by digitally acquiring the cards by lottery or the like, builds a deck by selecting a predetermined number of cards from the cards that the user owns in consideration of the classes, and plays the battle game with other users via the server apparatus 120 by using the built deck.

Note that in the embodiment, a piece of game content that can be used in the battle game is periodically added by the administrator of the battle game. A group identifier (for example, an ID including a number such as a first expansion, and a second expansion) in accordance with a timing at which the game content is added as a piece of game content that can be used in the battle game is assigned to each piece of game content. As one of the usages of the group identifier, there is a usage of providing a limitation on the building of the deck (for example, a limitation that only pieces of game content of an N-th expansion to an M-th expansion can be included in the deck) in order to enhance the appeal of the battle game.

In addition, in the embodiment, the server apparatus 120 records, for example, player information regarding a user (player) who plays a battle game for each user who participates in the battle game. Examples of the player information include information related to cards owned by the player, information related to decks built by the player in the past, and the like. Then, the server apparatus 120 updates the recorded player information or controls the progress of the battle game based on information output from the terminal apparatus 110 in accordance with an operation of the user.

Meanwhile, various battle games in which a piece of game content that can be included in a deck is periodically added have been studied, but in such a known battle game, the new piece of game content is often set to have stronger abilities than old pieces of game content. Thus, in the battle game in the related art, it may be difficult to establish a battle between a deck including new pieces of game content and a deck including old pieces of game content without losing appeal, and in this regard, there is room for further enhancing the appeal of the battle game.

Thus, according to the embodiment, a technique, which will be described in detail below, generates an advantageous or disadvantageous effect in the battle game based on the group identifiers of the pieces of game content included in the deck such that the battle between the deck including the new pieces of game content and the deck including the old pieces of game content is established without losing appeal, thereby achieving further enhancing the appeal of the battle game.

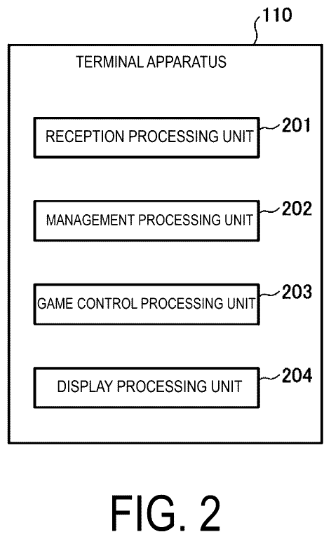

FIG. 2 is an exemplary and schematic block diagram illustrating a functional configuration of the terminal apparatus 110 according to the embodiment.

As illustrated in FIG. 2, the terminal apparatus 110 includes a reception processing unit 201, a management processing unit 202, a game control processing unit 203, and a display processing unit 204.

The reception processing unit 201 receives inputs of various operations of the user who uses the terminal apparatus 110. For example, the reception processing unit 201 receives selection of a format of the battle game (battle format, a specific example thereof will be described later) before the battle game is started, receives selection of a class of cards to be included in a deck to be used in the battle game, and receives selection of the cards to be included in the deck after the class is selected.

The management processing unit 202 manages the deck built in accordance with the operations of the user. For example, the management processing unit 202 may manage a group identifier of pieces of game content that can be included in the deck, based on the format selected by the user.

The game control processing unit 203 controls the progress of the battle game in cooperation with the server apparatus 120 through communication. Further, the display processing unit 204 controls output of an image related to the battle game to the display 110A.

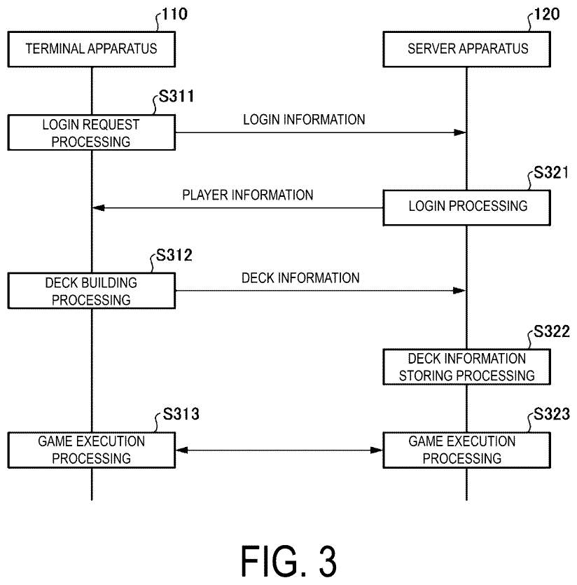

Based on the functional configuration as described above, the terminal apparatus 110 according to the embodiment executes various processing in cooperation with the server apparatus 120 in accordance with a procedure as illustrated in FIG. 3, which will be described below, when providing the battle game to the user.

FIG. 3 is an exemplary and schematic sequence diagram illustrating a procedure of processing that is performed by the terminal apparatus 110 and the server apparatus 120 according to the embodiment.

As illustrated in FIG. 3, in the embodiment, the terminal apparatus 110 (for example, the game control processing unit 203) first performs login request processing for acquiring player information of the user of the terminal apparatus 110 from the server apparatus 120 in S311 and transmits login information including identification information of the user and the like to the server apparatus 120. The processing in S311 is performed, for example, when an application installed in the terminal apparatus 110 is started to provide the battle game.

Then, the server apparatus 120 performs login processing based on the login information received from the terminal apparatus 110 in S321, extracts the corresponding player information from player information recorded by the server apparatus 120, and transmits the extracted player information to the terminal apparatus 110.

Then, the terminal apparatus 110 (for example, the reception processing unit 201, the management processing unit 202, and the display processing unit 204) performs deck building processing of building a deck to be used in the battle game in response to an operation of the user in S313 and transmits deck information regarding the built deck to the server apparatus 120. As will be described in detail later, the deck building processing is processing of managing the deck by the management processing unit 202 while receiving the operation of the user by the reception processing unit 201 and displaying various images (screens) on the display 110A by the display processing unit 204 as necessary.

Then, the server apparatus 120 performs, in S322, deck information storing processing of storing the deck information received from the terminal apparatus 110 and updating the player information recorded in the server apparatus 120.

Then, the terminal apparatus 110 (for example, the reception processing unit 201, the game control processing unit 203, and the display processing unit 204) and the server apparatus 120 perform game execution processing of executing the battle game in cooperation with each other through communication in S313 and S323, respectively. The game execution processing is processing of controlling the progress of the game by the game control processing unit 203 while receiving the operation of the user by the reception processing unit 201 and displaying various images (screens) on the display 110A by the display processing unit 204.

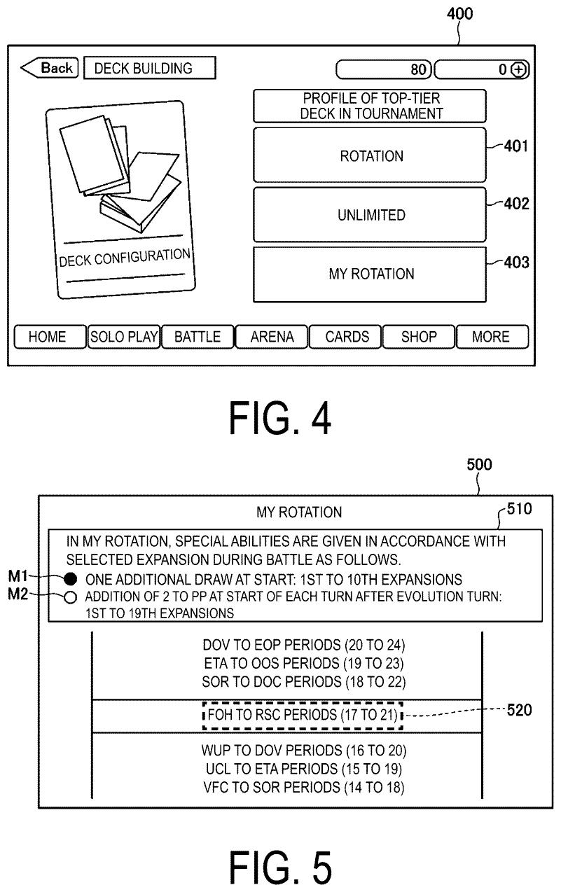

Here, in the embodiment, in the deck building processing of S312 as described above, first, processing of causing the user to select a format of the battle game is performed through a format selection screen as illustrated in FIG. 4, which will be described below.

FIG. 4 is an exemplary and schematic diagram illustrating an example of the format selection screen according to the embodiment.

An image 400 illustrated in FIG. 4 is an example of the format selection screen. The image 400 includes a first button 401 for receiving selection of a “ROTATION” format, a second button 402 for receiving selection of an “UNLIMITED” format, and a third button 403 for receiving selection of a “MY ROTATION” format.

The “ROTATION” format that can be selected by the first button 401 is a format in which pieces of game content that can be included in a deck to be used for a battle are limited to pieces of game content of a predetermined number (for example, five) of expansions including the most recent expansion. In addition, the “UNLIMITED” format that can be selected by the second button 402 is a format in which pieces of game content that can be included in a deck to be used for a battle are pieces of game content of all expansions released so far.

In addition, the “MY ROTATION” format that can be selected by the third button 403 is a format in which pieces of game content that can be included in a deck to be used for a battle are limited to pieces of game content of a predetermined number (five) of expansions that are continuous among all expansions released so far. The “MY ROTATION” format is a new format that enables a battle using a past “ROTATION” deck and a recent “ROTATION” deck, for example.

Here, as described above, since a new piece of game content is often set to have stronger abilities than old pieces of game content, it may be difficult to establish a battle between a deck including the new pieces of game content and a deck including the old pieces of game content without losing appeal.

Thus, in the “MY ROTATION” format according to the embodiment, a reference group identifier is determined from among the group identifiers of the pieces of game content included in the deck, and processing of generating an effect in accordance with the reference group identifier is performed when a battle game is provided. For example, in the embodiment, a group identifier assigned to a piece of game content added at the most recent timing among group identifiers assigned to pieces of game content included in a deck may be used as a reference group identifier. Then, in the embodiment, the game progresses such that a more advantageous effect is generated as the above-described timing indicated by the reference group identifier is less recent.

Note that the above effect is not an effect generated to adjust information (abilities) set in advance for the pieces of game content, but an effect generated to adjust information related to rules of the battle game as displayed on a group selection screen illustrated in FIG. 5, which will be described below.

FIG. 5 is an exemplary and schematic diagram illustrating an example of the group selection screen according to the embodiment.

An image 500 illustrated in FIG. 5 is an example of the group selection screen. The image 500 may be displayed on the display 110A after the format is selected by the user through the image 400 (see FIG. 4) and after the class of the cards to be included in the deck is selected by the user.

The image 500 includes an area 510 in which an explanation about an effect that may occur in “MY ROTATION” is displayed, and an area 520 in which a range currently selected is displayed as a range of pieces of game content that can be included in the deck of “MY ROTATION”.

To be more specific, in the area 510, explanations of effects that may occur in “MY ROTATION” are displayed together with corresponding marks M1 and M2. The mark M1 is a special ability icon for clearly indicating to the user that an effect (special ability) being advantageous in terms of the rules of the battle game, such as “ONE ADDITIONAL DRAW AT START”, occurs when the group identifier of the most recent pieces of game content included in the deck is in a range of the first to tenth expansions. In a normal state without any special abilities, a rule is such that the player draws one card from the deck in each turn during the battle, whereas in a state in which the special ability “ONE ADDITIONAL DRAW AT START” is generated, the rule is made such that the player draws, from the deck, one more card in addition to the one card normally drawn (that is, two cards in total) in each turn during the battle. Thus, the player on the side where the special ability is generated is more advantageous than the player on the side where the special ability is not generated. In addition, the mark M2 is a special ability icon for clearly indicating to the user that an advantageous effect in terms of the rules of the battle game, such as “ADDITION OF 2 TO PP AT START OF EACH TURN AFTER EVOLUTION TURN”, occurs when the group identifier of the most recent pieces of game content included in the deck is in a range of the first to nineteenth expansions. In a normal state without any special ability, a rule is such that a parameter called PP (play point) and required for using a card increases by one in each turn during the battle, whereas in a state where a special ability “ADDITION OF 2 TO PP AT START OF EACH TURN AFTER EVOLUTION TURN” is generated, the rule is made such that the parameter called PP increases by two after a specific turn during the battle. Thus, the player on the side where the special ability is generated is more advantageous than the player on the side where the special ability is not generated.

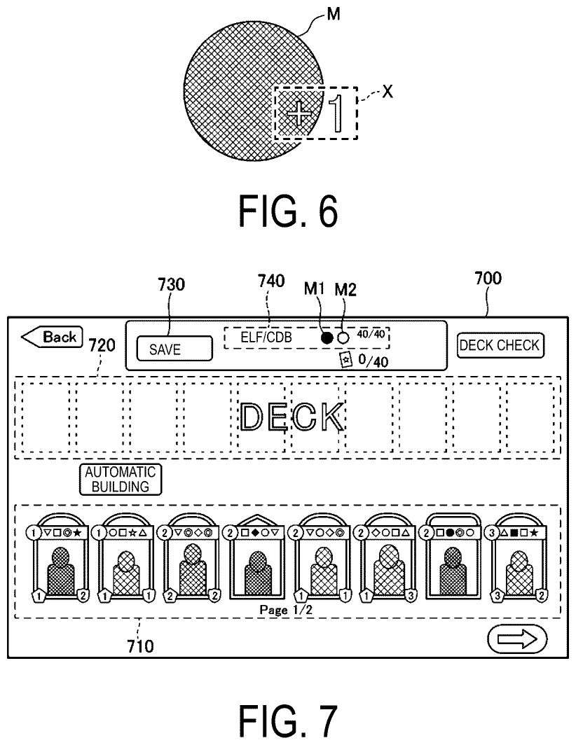

Note that in the example illustrated in FIG. 5, the special ability icons are displayed as the simple circular marks M1 and M2. However, the special ability icon may be displayed including character information as illustrated in FIG. 6.

FIG. 6 is an exemplary and schematic diagram illustrating an example of the special ability icon according to the embodiment.

In the example illustrated in FIG. 6, a circular mark M indicating the special ability icon is displayed together with a character display X of “+1”. This character display X of “+1” may be displayed, for example, in association with the special ability “ONE ADDITIONAL DRAW AT START” described above. Note that it is needless to say that the content of the character display X is not limited to “+1”. In the embodiment, the character display X indicating various pieces of content may be displayed together with the mark M in accordance with the special ability to be generated.

Referring back to FIG. 5, in the area 520, a range of 17th to 21st expansions is selected as a range of pieces of game content that can be included in the deck of “MY ROTATION”. In this case, since the most recent group identifier of the pieces of game content that can be included in the deck is the 21st expansion, any effects corresponding to the marks M1 and M2 are not generated. Note that characters of “FOH TO RSC PERIODS” in the area 520 indicate a range of the group identifiers (release timings) of the pieces of game content and only indicate numerals of “17 TO 21” displayed next to the characters in another format. Note that in the example illustrated in FIG. 5, the pieces of game content up to the 24th expansion are divided into one range per five successive expansions. The user can select a desired range from the plurality of divided ranges. Note that the criterion for dividing the expansions for every five successive expansions as one range is merely an example. As another example, a criterion for dividing the expansions for every four or less successive expansions or six or more successive expansions as one range may be adopted. Further, the expansions included in one range need not necessarily be successive.

When the selection of the range through the image 500 described above (see FIG. 5) is completed, a deck building screen as illustrated in FIG. 7, which will be described below, may be displayed on the display 110A.

FIG. 7 is an exemplary and schematic diagram illustrating an example of the deck building screen according to the embodiment.

An image 700 illustrated in FIG. 7 is an example of the deck building screen. The image 700 includes a first area 710, a second area 720, a save button 730, and a third area 740.

In the first area 710, for example, a list of pieces of game content having a group identifier that can be included in a deck among cards digitally owned by the user is displayed. In addition, a list of cards in the deck is displayed in the second area 720. The user builds the deck by performing an operation (for example, a touch operation) of selecting a card displayed in the first area 710 and performing an operation (for example, a swipe operation) of moving the selected card into the second area 720. When an operation (for example, a touch operation) of the save button 730 is executed, the built deck is stored through determination of a condition such as whether or not the number of cards in the deck reaches a prescribed number.

Information related to the deck currently being built is displayed in the third area 740. In the example illustrated in FIG. 7, as the information related to the deck displayed in the third area 740, the name of a class (“ELF”) that can be included in the deck, characters (“CDB”) indicating the most recent group identifier of pieces of game content that can be included in the deck, and the marks M1 and M2 indicating effects (special abilities) that can be generated according to the deck are exemplified.

When the deck building in the deck building screen illustrated in FIG. 7 is completed, the user can play a battle game with another player by using the built deck.

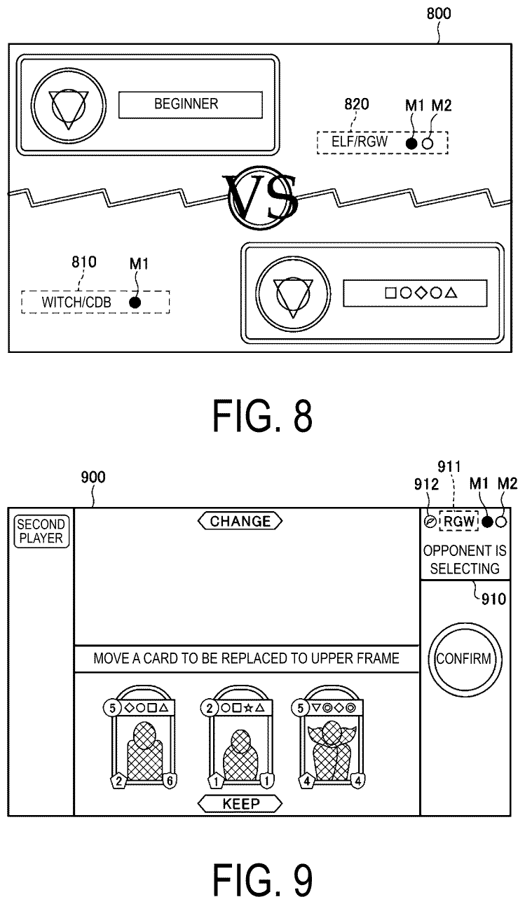

Note that it is desirable that the user can check the information related to the deck including an effect (special ability) that can be generated by the deck not only when the deck is built but also when the battle game is played. At the same time, it is desirable that not only the information related to the own deck but also information related to an opponent's deck can be checked. Thus, in the embodiment, the display processing unit 204 can notify the player of information related to the own deck and the opponent's deck by using images (screens) as illustrated in FIG. 8 to FIG. 11, which will be described below, when the player plays the battle game.

For example, in the embodiment, the display processing unit 204 may display a battle start screen as illustrated in FIG. 8, which will be described below, at the start of the battle game, and may display the information related to the own deck and the information related to the opponent's deck on the battle start screen.

FIG. 8 is an exemplary and schematic diagram illustrating an example of the battle start screen according to the embodiment.

An image 800 illustrated in FIG. 8 is an example of the battle start screen. The image 800 includes a first area 810 in which the information related to the own deck is displayed and a second area 820 in which the information related to the opponent's deck is displayed. As the information related to the deck, the name of a class (“ELF”) that can be included in the deck, characters (“CDB”) indicating the most recent group identifier of pieces of game content that can be included in the deck, and the mark M1 and/or the mark M2 each of which indicates an effect (special ability) that can be generated by the deck are displayed.

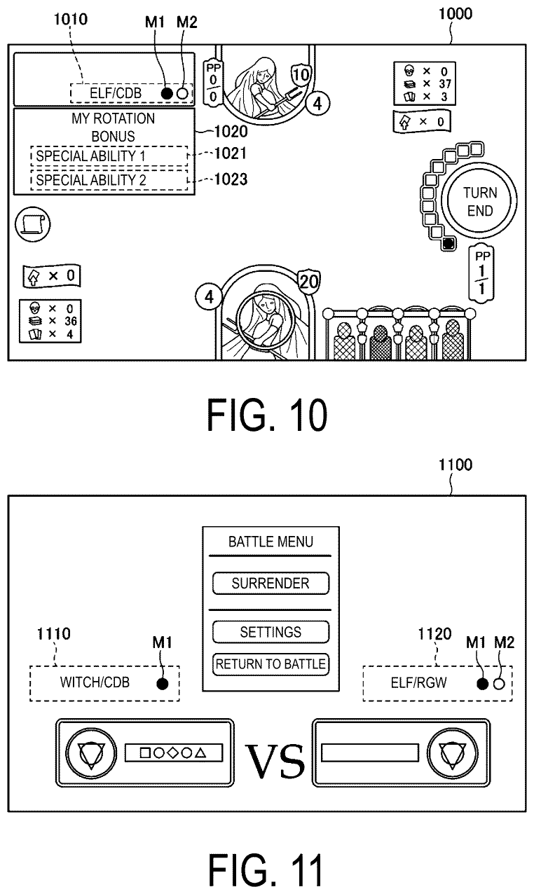

In addition, in the embodiment, the display processing unit 204 may display the information related to the opponent's deck on the battle screen in forms as illustrated in FIG. 9 and FIG. 10 after the start of the battle game.

FIG. 9 is an exemplary and schematic diagram illustrating an example of the battle screen according to the embodiment.

An image 900 illustrated in FIG. 9 is a screen for card redraw permitted in accordance with the rules, as a battle screen displayed immediately after the battle starts. An area 910 in which the information related to the opponent's deck is displayed is provided on the upper right of the image 900. In the area 910, as the information related to the opponent's deck, characters 911 indicating the group identifier of the most recent cards included in the deck being used by the opponent, a mark 912 indicating a class selected by the opponent at the time of deck building, and the marks M1 and M2 indicating the effects (special abilities) generated by the deck being used by the opponent are displayed. This allows the user to select whether to draw a card again while checking the information related to the opponent's deck.

Further, FIG. 10 is an exemplary and schematic diagram illustrating an example of the battle screen according to the embodiment, which is different from the example illustrated in FIG. 9.

An image 1000 illustrated in FIG. 10 is a battle screen displayed during the progress of the game after the card redraw through the image 900 described above (see FIG. 9) is completed. The left side of the image 1000 includes an area 1010 in which the information of the opponent's deck is displayed and an area 1020 in which an effect (special ability) generated by the opponent's deck is displayed. In the area 1010, as the information related to the opponent's deck, characters indicating the class selected by the opponent when the deck is built and the group identifier of the most recent cards included in the deck being used by the opponent, and the marks M1 and M2 indicating the effects generated by the deck being used by the opponent are displayed. Further, the area 1020 is provided with areas 1021 and 2023 in which explanations about the contents of the effects indicated by the marks M1 and M2 are displayed. These areas 1010 and 1020 are displayed in accordance with a predetermined operation of the player during the progress of the game. This allows the user to check the information related to the opponent's deck at a desired timing during the progress of the game.

Further, in the embodiment, as illustrated in FIG. 11, the class of the cards included in the deck can be displayed on a pause screen displayed during pausing after the start of the battle game. Note that the pause screen may be displayed in response to an operation (for example, a touch operation) of a pause button (not illustrated) provided on the battle screen.

FIG. 11 is an exemplary and schematic diagram illustrating an example of the pause screen according to the embodiment.

An image 1100 illustrated in FIG. 11 is an example of the pause screen. The image 1100 includes a first area 1110 and a second area 1120. In the first area 1110, characters (“WITCH”) indicating a class of the cards included in the own deck, characters (“CDB”) indicating a group identifier of the most recent cards included in the own deck, and the mark M1 indicating the effect (special ability) generated by the own deck are displayed. In addition, in the second area 1120, characters (“ELF”) indicating a class of the cards included in the opponent's deck, characters (“RGW”) indicating a group identifier of the most recent cards included in the opponent's deck, and the marks M1 and M2 indicating the effects generated by the opponent's deck are displayed. This allows the user to easily check the information related to the own deck and the information related to the opponent's deck during the pause of the battle game.

As described above, the system according to the embodiment provides a user with a battle game using a deck including a predetermined number of pieces of game content selected from among a plurality of pieces of game content each of which is assigned a group identifier, the plurality of pieces of game content being capable of being classified into a plurality of groups based on the group identifiers. The system determines a reference group identifier from among one or more group identifiers assigned to the predetermined number of pieces of game content included in the deck and generates an effect in accordance with the reference group identifier when the battle game is provided. These processes are performed by the terminal apparatus 110 with the server apparatus 120 mainly driving this processing, for example.

According to the above configuration, various effects for respective decks are generated based on the reference group identifiers, improving the balance of a battle and further enhancing the appeal of the battle game.

Note that in the embodiment, the effect is generated so as to not adjust information (ability) set in advance for the predetermined number of pieces of game content but adjust information related to rules of the battle game. According to such a configuration it is possible to improve the balance of the battle with smaller overhead than that of adjusting information related to the individual pieces of game content.

Further, in the embodiment, addition (release) of a new piece of game content to a plurality of pieces of game content is periodically performed. Then, a new group identifier different from the group identifier assigned to each of the plurality of pieces of game content is assigned to the new piece of game content. According to such a configuration, the group identifier can be easily managed in accordance with the timing of addition of the game content.

Here, in the embodiment, the reference group identifier is a group identifier assigned to a piece of game content added at the most recent timing among the one or more group identifiers assigned to the predetermined number of pieces of game content included in the deck. According to such a configuration, the newness of the game content included in the deck is used as the reference group identifier serving as an index regarding improvement of the balance of the battle, appropriately enhancing the appeal of the battle game.

Further, in the embodiment, the less recent the timing indicated by the reference group identifier is, the more advantageous the effect is. According to such a configuration, a battle can be established between a deck including new pieces of game content and a deck including old pieces of game content without losing appeal.

Finally, hardware configurations of the terminal apparatus 110 and the server apparatus 120 according to the above-described embodiments will be described. The terminal apparatus 110 and the server apparatus 120 according to the embodiment is configured as an information processing apparatus 1200 having a hardware configuration equivalent to that of a computer that is generally used, for example, as illustrated in FIG. 12.

FIG. 12 is an exemplary and schematic block diagram illustrating the hardware configuration of the information processing apparatus 1200 configuring each of the terminal apparatus 110 and the server apparatus 120 according to the embodiment.

As illustrated in FIG. 12, the information processing apparatus 1200 includes a processor 1210, a memory 1220, a storage 1230, an input/output interface (I/F) 1240, and a communication interface (I/F) 1250. These hardware components are connected to a bus 1260.

The processor 1210 is configured as, for example, a central processing unit (CPU), and comprehensively controls an operation of each unit of the information processing apparatus 1200.

The memory 1220 includes, for example, a read only memory (ROM) and a random access memory (RAM) and achieves volatile or non-volatile storage of various types of data such as a program to be executed by the processor 1210, provision of a work area for the processor 1210 to execute the program, and the like.

The storage 1230 includes, for example, a hard disk drive (HDD) or a solid state drive (SSD) and stores various types of data in a non-volatile manner.

The input/output interface 1240 controls input of data from an input device such as a touch panel, a keyboard, and a mouse to the information processing apparatus 1200, and output of data from the information processing apparatus 1200 to an output device such as a display and a speaker.

The communication interface 1250 enables the information processing apparatus 1200 to communicate with other apparatuses.

The functional configuration of the terminal apparatus 110 according to the embodiment (see FIG. 2) is implemented as a functional module group by cooperation of hardware and software as a result of the processor 1210 executing the program stored in advance in the memory 1220 or the storage 1230. However, in the embodiment, one or some, or all of units included in the functional module group illustrated in FIG. 2 may be implemented only by hardware such as a circuit (circuitry) exclusively designed. Further, in the embodiment, at least one or some of the units included in the functional module group illustrated in FIG. 2 may be implemented on the server apparatus 120 side.

Note that the above-described program does not necessarily need to be stored in advance in the memory 1220 or the storage 1230. For example, the above-described program may be provided as a computer program product recorded in an installable format or an executable format on a computer-readable medium such as various magnetic disks such as a flexible disk (FD) or various optical disks such as a digital versatile disk (DVD).

Further, the program described above may be provided or distributed via a network such as the Internet. That is, the above-described program may be provided, in a state of being stored in a computer connected to a network such as the Internet, by being downloaded via the network.

### Modified Examples

In the above-described embodiment, the configuration in which a more advantageous special ability is given to a deck having an older reference group identifier has been exemplified. However, an equivalent result can be obtained by a configuration in which a more disadvantageous special ability is assigned to a deck having a newer reference group identifier. As an example of such a configuration, a configuration is conceivable in which a parameter related to a play, such as physical power, decreases as a deck has a newer reference group identifier. In this case, no special ability is given to a deck having a reference group identifier older than a predetermined value, and a disadvantageous effect corresponding to the newness of the deck can be generated only for a deck having a reference group identifier newer than the predetermined value.

Further, in the above-described embodiment, the configuration in which the reference group identifier is determined from among the group identifiers of the pieces of game content included in the deck has been exemplified. However, a configuration is also conceivable in which the reference group identifier is determined in accordance with the selection of the range of the group identifiers of the pieces of game content to be included in the deck by the user when the deck is built. Such selection is performed using, for example, the image 500 illustrated in FIG. 5 described above. In this case, the reference group identifier is a group identifier corresponding to the most recent expansion in the selected range.

Further, in the above-described embodiment, the configuration has been exemplified in which the effect generated in accordance with the reference group identifier is generated so as to adjust information regarding the rules of the battle game. However, the effect generated in accordance with the reference group identifier may be an effect of adjusting information (ability) set in advance for each of the pieces of game content.

Furthermore, in the embodiment described above, the configuration has been exemplified in which the effect of “ONE ADDITIONAL DRAW AT START” is generated for a deck including a piece of game content in a range of the first to tenth expansions as the most recent piece of game content, and the effect of “ADDITION OF 2 TO PP AT START OF EACH TURN AFTER EVOLUTION TURN” is generated for a deck having a piece of game content in a range of the first to nineteenth expansions as the most recent piece of game content. However, as another example, a configuration is also conceivable in which the following effects are generated.

For example, a configuration is conceivable in which the following effects are generated for a deck including a piece of game content in the range of the first to tenth expansions as the most recent piece of game content:
An effect of “limited to three turns from an evolution turn, addition of 2 to PP and recovery of physical power by 2 at the start of each turn” (PP is as described above, and the physical power is one of parameters given to each character on the player side)
An effect of “recovery of EP by 2 if EP is 0 at the start of a turn once during a battle” (EP is a parameter determined in a rule as a point given to a player in order to generate an additional ability for a piece of card content during a battle)
An effect of “two additional card draws on a first turn” (this effect is similar to the above-described effect of “ONE ADDITIONAL DRAW AT START”, and thus, description thereof will be omitted)

Then, the following effects are generated for a deck having a piece of game content in a range of the eleventh and subsequent expansions (for example, up to the seventeenth expansion) as the most recent piece of game content:
An effect of “limited to a first turn from an evolution turn, addition of 2 to PP and recovery of physical power by 2 at the start of the turn” (this effect is the same or a similar type of effect as or to the above-described effect of “limited to three turns from an evolution turn, addition of 2 to PP and recovery of physical power by 2 at the start of each turn”, but an obtained advantage is smaller than that of the above-described effect)
An effect of “recovery of EP by 1 if EP is 0 at the start of a turn once during a battle” (this effect is the same or a similar type of effect as or to the above-described effect of “recovery of EP by 2 if EP is 0 at the start of a turn once during a battle”, but an obtained advantage is smaller than that of the above-described effect)
An effect of “one additional card draw on a first turn” (this effect is the same or similar type of effect as or to the above-described effect of “two additional card draws on a first turn”, but an obtained advantage is smaller than the above-described effect) According to such configurations, the degree of advantage is made different between new expansions and old expansions while the same or a similar type of effect is generated, improving the balance of the battle.

Although the embodiments and the modified examples of the present disclosure have been described above, the embodiments and the modified examples are presented as examples and are not intended to limit the scope of the invention. The novel embodiments and modified examples described herein may be embodied in a variety of other forms; furthermore, various omissions, substitutions, and changes in the forms of the embodiments and modified examples described herein may be made without departing from the gist of the invention. These embodiments and modified examples are included in the scope or the gist of the invention and are included in the invention described in the claims and the scope of equivalents thereof.

### REFERENCE SIGNS LIST

110 Terminal apparatus
120 Server apparatus
201 Reception processing unit
202 Management processing unit
203 Game control processing unit
204 Display processing unit

What is claimed is:

1. A non-transitory computer readable medium storing a program for providing a user with a battle game using a deck including a predetermined number of pieces of game content selected from among a plurality of pieces of game content each of which is assigned a group identifier, the plurality of pieces of game content being capable of being classified into a plurality of groups based on the group identifier, the program causing a computer to execute:
determining at least one group identifier as a reference group identifier; and
generating an effect in accordance with the reference group identifier when the battle game is provided.

2. The non-transitory computer readable medium according to claim 1, wherein
the reference group identifier is determined from among one or more group identifiers assigned to the predetermined number of pieces of game content included in the deck.

3. The non-transitory computer readable medium according to claim 1, wherein
the effect is generated by not adjusting information set in advance for the predetermined number of pieces of game content but adjusting information related to a rule of the battle game.

4. The non-transitory computer readable medium according to claim 1, wherein
adding a new piece of game content to the plurality of pieces of game content is periodically performed, and
the new piece of game content is assigned a new group identifier different from the group identifier assigned to each of the plurality of pieces of game content.

5. The non-transitory computer readable medium according to claim 4, wherein
the reference group identifier is a group identifier assigned to a piece of game content added at a most recent timing among the one or more group identifiers assigned to the predetermined number of pieces of game content included in the deck.

6. The non-transitory computer readable medium according to claim 5, wherein
the effect is more advantageous as the timing indicated by the reference group identifier is less recent.

7. A method executed by a computer for providing a user with a battle game using a deck including a predetermined number of pieces of game content selected from among a plurality of pieces of game content each of which is assigned a group identifier, the plurality of pieces of game content being capable of being classified into a plurality of groups based on the group identifier, the method comprising:
determining at least one group identifier as a reference group identifier; and
generating an effect in accordance with the reference group identifier when the battle game is provided.

8. A system for providing a user with a battle game using a deck including a predetermined number of pieces of game content selected from among a plurality of pieces of game content each of which is assigned a group identifier, the plurality of pieces of game content being capable of being classified into a plurality of groups based on the group identifier, the system comprising:
determining at least one group identifier as a reference group identifier; and
generating an effect in accordance with the reference group identifier when the battle game is provided.
